(19) United States
(12) Patent Application Publication
(10) Pub. No.: US 2003/0016807 A1
(43) Pub. Date: Jan. 23, 2003

(54) Voice CODEC designating system

(75) Inventor: Kiyokazu Otsuka, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/200,482

(22) Filed: Jul. 23, 2002

(30) Foreign Application Priority Data
Jul. 23, 2001 (JP) 2001-221738

(51) Int. Cl. H04M 7/00; H04L 12/66

(52) U.S. Cl. 379/219; 370/352

(57) ABSTRACT

In an IP telephone system 10 enabling a voice telephone communication between a pair of subscriber's talking terminals 100 and 110 respectively connected to a pair of private branch exchanges 200 and 210 interconnected through an IP network 400, by utilizing VoIP gateway functions respectively provided in the pair of private branch exchanges 200 and 210 and by action of a voice conversion based on a voice CODEC, when the subscriber's talking terminal 100 of a calling party side dispatches a telephone calling, the subscriber's talking terminal 100 of the calling party side sends a voice CODEC change designating access code and a voice CODEC designating code to the private branch exchange 200 of the calling party side and the private branch exchange 210 of a called party side. Each private branch exchange discriminates the access code supplied from the subscriber's talking terminal of the calling party side, and registers a voice CODEC designated by the voice CODEC designating code, into a voice converter 204, 214 provided in each private branch exchange.

### BACKGROUND OF THE INVENTION

The present invention relates to a so-called IP telephone system for a voice telephone communication between subscriber's talking terminals (such as a telephone set) respectively connected to a plurality of private branch exchanges which are interconnected through an IP (Internet Protocol) network such as an Internet, and more specifically to a system capable of arbitrarily designating a voice CODEC (coder and decoder) for processing voices transmitted and received in the IP telephone system.

Heretofore, in the case of carrying out a voice telephone communication by utilizing a VoIP (Voice over Internet Protocol) gateway function from a subscriber's talking terminal (extension telephone set) connected to a private branch exchange, over an IP (Internet Protocol) network such as an Internet or an intranet, when a telephone call is dispatched, a negotiation is carried out in connection with a voice CODEC previously set in the system or a voice CODEC used to communicate with a destination private branch exchange, and then, a voice is converted into a packet signal by a voice converter by using the voice CODEC determined as the result of the negotiation, so that a voice packet is transmitted.

In any case, since the voice CODEC used in the voice converter is automatically determined by the IP telephone system, it is not possible to use the voice CODEC desired by a calling party at the time of dispatching a telephone call.

### BRIEF SUMMARY OF THE INVENTION

Accordingly, it is an object of the present invention to provide a voice CODEC designating system which has overcome the above mentioned problem of the prior art in the IP telephone system.

Another object of the present invention is to provide a voice CODEC designating system making it possible to convert an analog voice signal into a digital packet signal by a voice converter using the voice CODEC designated by a calling party at the time of dispatching a telephone call.

In order to achieve the above and other objects of the present invention, in an IP telephone system enabling a voice telephone communication between a pair of subscriber's talking terminals connected respectively to a pair of private branch exchanges interconnected through an IP network, by utilizing VoIP gateway functions respectively provided in the pair of private branch exchanges, and by registering a voice CODEC in a voice converter provided in each of the pair of private branch exchanges, according to the present invention there is provided a voice CODEC designating system having such a configuration in that

each of the subscriber's talking terminals has a means for sending a voice CODEC change designating access code and a voice CODEC designating code to the private branch exchange of a calling party side and the private branch exchange of a called party side, when the subscriber's talking terminal of the calling party side dispatches a telephone calling, and

each of the private branch exchanges discriminates the voice CODEC change designating access code supplied from the subscriber's talking terminal of the calling party side, and registers a voice CODEC designated by the voice CODEC designating code, into the voice converter provided in each of the private branch exchanges.

With the voice CODEC designating system mentioned above, if a subscriber desires to use the voice CODEC designated by the subscriber, when the subscriber dispatches a telephone calling, the subscriber sends the voice CODEC change designating access code and the voice CODEC designating code from the subscriber's talking terminal to both the private branch exchanges of the calling party side and the called party side.

The private branch exchange of the calling party side receives the voice CODEC change designating access code and the voice CODEC designating code directly from the subscriber's talking terminal, and the private branch exchange of the called party side receives the voice CODEC change designating access code and the voice CODEC designating code through the IP network from the subscriber's talking terminal of the calling party side. Both the private branch exchanges of the calling party side and the called party side discriminate the voice CODEC change designating access code, and then, register the voice CODEC designated by the voice CODEC designating code, into the associated voice converter.

Thus, the private branch exchanges of the calling party side and the called party side connect between the talking terminal of the calling party side and the talking terminal of the called party side through the IP network, so that a voice telephone communication is established between the talking terminal of the calling party side and the talking terminal of the called party side by using the voice CODEC designated by the subscriber.

Accordingly, according to the present invention, when a voice telephone communication is carried out between talking terminals respectively connected to private branch exchanges interconnected through an IP network such as an Internet or an intranet, a voice telephone communication can be realized by arbitrarily designating a voice CODEC desired by the subscriber of a calling party, for example, a voice CODEC needing a more wide bandwidth, or a voice CODEC having a high compression ratio in the case of a bad channel situation, dependently upon the traffic situation of the channel or a desired voice quality.

In an embodiment of the voice CODEC designating system in accordance with the present invention, each of the private branch exchanges includes an access code discriminating means for discriminating the voice CODEC change designating access code from the subscriber's talking terminal of the calling party side, a voice CODEC designating means for designating the voice CODEC on the basis of the voice CODEC designating code, and a voice CODEC registering means for registering the voice CODEC designated by the voice CODEC designating means, into the corresponding voice converter.

With this arrangement, each of the private branch exchanges detects the intention of the change of the voice CODEC of the subscriber of the calling party side, by action of the access code discriminating means which discriminates the voice CODEC change designating access code supplied from the subscriber's talking terminal of the calling party side. Furthermore, each of the private branch exchanges designates the voice CODEC by action of the voice CODEC designating means on the basis of the voice CODEC designating code supplied from the subscriber's talking terminal of the calling party side. Each of the private branch exchanges also registers the designated voice CODEC into the corresponding voice converter by action of the voice CODEC registering means.

In an embodiment of the voice CODEC designating system in accordance with the present invention, preferably, each of the private branch exchanges further includes a voice CODEC registration notifying means for notifying to the subscriber's talking terminal of the calling party side, whether or not the voice CODEC designated by the voice CODEC designating means has been normally registered into the voice converter by the voice CODEC registering means.

With this arrangement, since the voice CODEC registration notifying means of each private branch exchange notifies to the subscriber's talking terminal of the calling party side, whether or not the voice CODEC designated by the calling party has been normally registered into the voice converter by the voice CODEC registering means, the calling party can know whether or not the voice CODEC designated by the calling party has been normally registered.

In a specific embodiment of the voice CODEC designating system in accordance with the present invention, preferably, each of the private branch exchanges is connected through the IP network to a maintenance terminal, which previously sets a voice CODEC to the voice converter of each of the private branch exchanges, and when each of the private branch exchanges receives the voice CODEC change designating access code and the voice CODEC designating code supplied from the subscriber's talking terminal of the calling party side, each of the private branch exchanges preferentially registers the voice CODEC designated through the subscriber's talking terminal of the calling party side into the corresponding voice converter.

With this arrangement, when each private branch exchange receives the voice CODEC change designating access code and the voice CODEC designating code supplied from the subscriber's talking terminal of the calling party side, each private branch exchange preferentially registers the voice CODEC designated through the subscriber's talking terminal of the calling party side into the corresponding voice converter. On the other hand, when each private branch exchange does not receive the voice CODEC change designating access code and the voice CODEC designating code from the subscriber's talking terminal of the calling party side, each private branch exchange uses the voice CODEC previously set to the voice converter by the maintenance terminal.

More specifically, each of the private branch exchanges includes a plurality of VoIP gateway devices, and the maintenance terminal defines a different gateway ID for each of the VoIP gateway devices, and sets a voice CODEC for each gateway ID.

With this arrangement, if each private branch exchange sets a different voice CODEC for the gateway ID of each VoIP gateway device, when the subscriber dispatches a telephone calling, it is possible to individually register the voice CODEC designated by the subscriber, into the voice converter, for the selected VoIP gateway device.

Furthermore, when the subscriber's talking terminal of the calling party side dispatches the telephone calling, the private branch exchange connected to the subscriber's talking terminal of the calling party side identifies the private branch exchange connected to the subscriber's talking terminal of the called party side, and selects from the plurality of VoIP gateway devices the VoIP gateway device connectable to the private branch exchange connected to the subscriber's talking terminal of the called party side, and then, registers the voice CODEC designated through the subscriber's talking terminal of the calling party side, into the voice converter in the private branch exchange connected to the subscriber's talking terminal of the calling party side, for the VoIP gateway device thus selected.

With this arrangement, when the subscriber dispatches a telephone calling, the private branch exchange connected to the subscriber's talking terminal of the calling party side identifies the VoIP gateway device and the private branch exchange which should constitute a transmission channel to the subscriber's talking terminal of the called party side, and the voice CODEC designated through the subscriber's talking terminal of the calling party side, is registered into the voice converter in the private branch exchange connected to the subscriber's talking terminal of the calling party side, for the selected VoIP gateway device.

The above and other objects, features and advantages of the present invention will be apparent from the following description of preferred embodiments of the invention with reference to the accompanying drawings.

### BRIEF DESCRIPTION OF THE DRAWINGS

FIG. 1 is a block diagram of an IP telephone system incorporating one embodiment of the voice CODEC designating system in accordance with the present invention;

FIG. 2 illustrates an example of the VoIP gateway information structure used in the IP telephone system shown in FIG. 1; and

FIG. 3 is a flow chart illustrating an operation of the IP telephone system shown in FIG. 1.

### DETAILED DESCRIPTION OF THE INVENTION

Now, an embodiment of the present invention will be described with reference to the accompanying drawings.

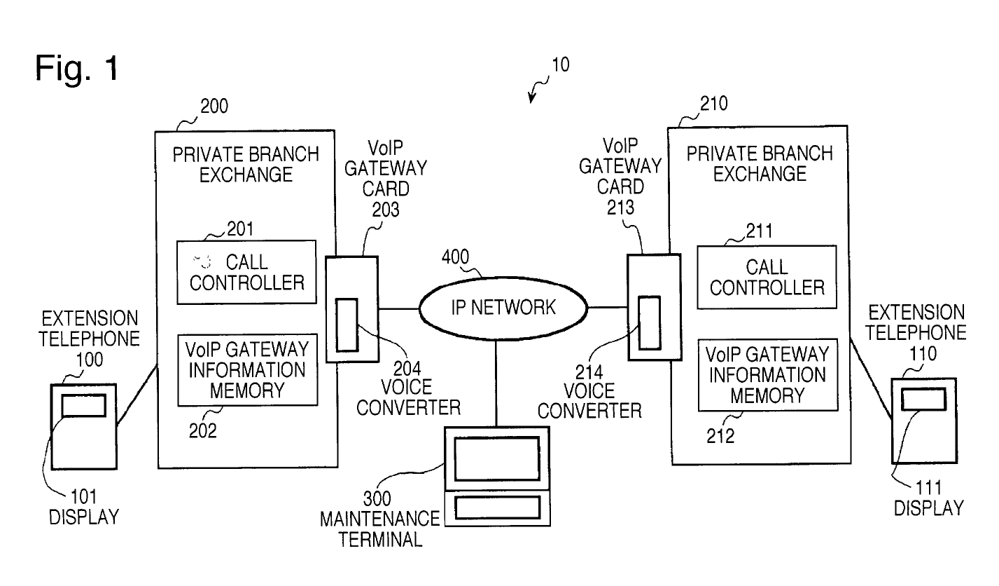

An IP telephone system incorporating one embodiment of the voice CODEC designating system in accordance with the present invention will be described with reference to FIG. 1, which is a block diagram of the IP telephone system incorporating the embodiment of the present invention.

As shown in FIG. 1, the IP telephone system, generally designated with the reference number 10, includes an individual extension telephone set 100 which is for example a talking terminal at a calling party side, another individual extension telephone set 110 which is for example a talking terminal at a called party side, a calling party side private branch exchange 200 to which the extension telephone set 100 is connected, a called party side private branch exchange 210 to which the extension telephone set 110 is connected, a maintenance terminal 300, and an IP network 400, which are connected as shown.

Incidentally, only two extension telephone sets 100 and 110 and only two private branch exchanges 200 and 210 are shown in FIG. 1, but it would be understandable that the number of the extension telephone sets and the number of the private branch exchanges are in no way limited to two.

In addition, the IP network 400 is a network exemplified by an Internet or an intranet, and is configured to provide an Internet connection services.

Each of the two extension telephone sets 100 and 110 is a telephone set terminal including an interface (not shown) for carrying out a voice telephone communication transmitted and received through the IP network 400, and is given with a telephone number for each subscriber, similarly to a conventional telephone.

Further, each of the two extension telephone sets 100 and 110 comprises a display part 101 or 111 as shown in FIG. 1, and includes a handset, a transmitter, a receiver and a keyboard unit for input operation (all not shown), similarly to the conventional telephone set.

However, each of the two extension telephone sets 100 and 110 is not necessarily required to be a conventional telephone set, but may be constituted of an application software realizing a telephone function operating on a personal computer.

Each of the private branch exchanges 200 and 210 is a higher rank apparatus to which the extension telephone set 100 or 110 is connected, and includes at least a VoIP gateway information memory 202 or 212 and a call controller 201 or 211, which can be realized in for example a program-controlled microcomputer included in the private branch exchange.

Furthermore, each of the private branch exchanges 200 and 210 is connected to the IP network 400 through a VoIP gateway card 203 or 213.

Each of the call controllers 201 and 211 receives and analyzes a control command supplied from an associated subscriber's extension telephone set 100 or 110 or through the IP network 400, and thereafter, sends a control information to the subscriber's extension telephone set 100 or 110 or the IP network 400. Namely, a so-called subscriber call control system is realized.

Furthermore, each of the call controllers 201 and 211 has an access code discriminating function and a voice CODEC designating function.

The access code discriminating function discriminates an access code which is supplied from the associated subscriber's extension telephone set 100 or 110 for instructing the change of the voice CODEC. When the access code discriminating function has recognized the instruction of the change of the voice CODEC, the voice CODEC designating function designates the voice CODEC on the basis of a voice CODEC designating code supplied from the associated subscriber's extension telephone set.

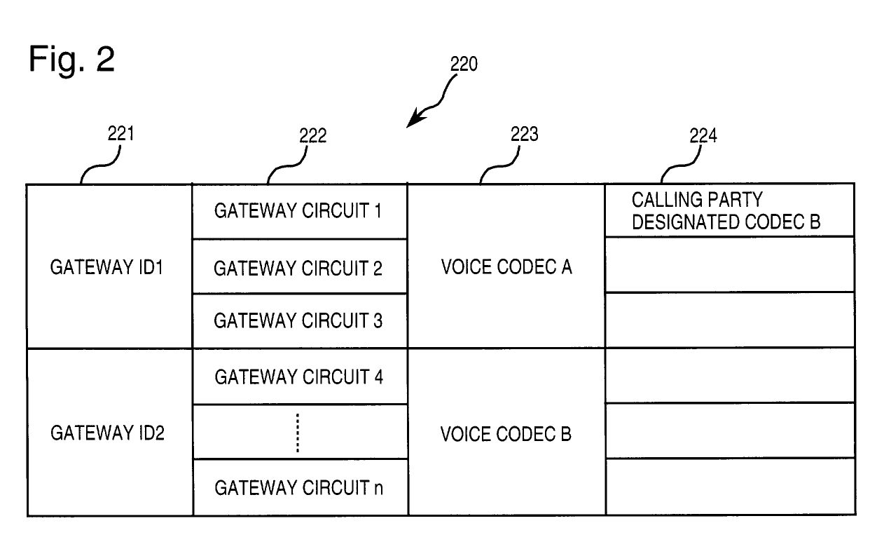

In each of the VoIP gateway information memories 202 and 212, it is possible to register a voice CODEC. VoIP gateway information 220 (as shown in FIG. 2) is registered in each of the VoIP gateway information memories 202 and 212.

As shown in FIG. 2, this VoIP gateway information 220 includes a voice CODEC 223 previously registered for each of gateway circuits in the VoIP gateway card 203 or 213, and if necessary, a voice CODEC 224 designated and registered by the voice CODEC designating function of the call controller 201 or 211.

In FIG. 2, a gateway ID 221 indicates the VoIP gateway card 203 or 213 in the private branch exchange 200 or 210. A gateway circuit 222 indicates each of gateway circuits provided in each VoIP gateway card 203 or 213.

In the shown example, the gateway ID 221 includes a gateway “IDl” and a gateway “ID2”. The gateway “IDI” includes gateway circuits “1” to “3”, and a voice CODEC “A” is previously registered as the voice CODEC 223. On the other hand, the gateway “ID2” includes gateway circuits “4” to “n”, and a voice CODEC “B” is previously registered as the voice CODEC 223.

Before a start of an operation of the IP telephone system 10, the VoIP gateway information 220 is registered from the maintenance terminal 300 through the IP network 400 into the VoIP gateway information memory 202 or 212 in each private branch exchange 200 or 210. In addition, when a subscriber of a calling party designates the voice CODEC, for each calling there is registered a voice CODEC 224 designated in connection with the gateway circuit within the VoIP gateway card 203 or 213 used by the calling concerned, namely, a calling party designated voice CODEC, for example, the calling party designated voice CODEC “B” in the example shown in FIG. 2.

Each of the VoIP gateway cards 203 and 213 includes a voice converter 204 or 214 for carrying out a voice conversion in accordance with the voice CODEC registered for each gateway circuit. For each calling, reference is made to the VoIP gateway information 220 registered in the VoIP gateway information memory 202 or 212, and a voice CODEC 223 or 224 predetermined in connection with the gateway circuit to be used is registered in the voice converter 204 or 214.

The maintenance terminal 300 is connected to the IP network 400, and can be constituted of an information processing terminal such as a personal computer.

In the maintenance terminal 300, the VoIP gateway information 220 excluding the calling party designated voice CODEC 224 is registered. Before the start of the operation of the IP telephone system 10, the maintenance terminal 300 sends and registers the VoIP gateway information 220 in the VoIP gateway information memory 202 or 212 in each private branch exchange 200 or 210 through the IP network 400.

With this arrangement, just before the start of the operation of the IP telephone system 10, the VoIP gateway information 220 including the voice CODEC 223 previously set in connection with each gateway circuit in the VoIP gateway card 203 or 213 has been registered in each VoIP gateway information memory 202 or 212.

Incidentally, the maintenance terminal 300 is independently provided in the shown embodiment, but one of the private branch exchanges 200 and 210 can comprise a function corresponding to the maintenance terminal 300, in place of a discrete maintenance terminal 300.

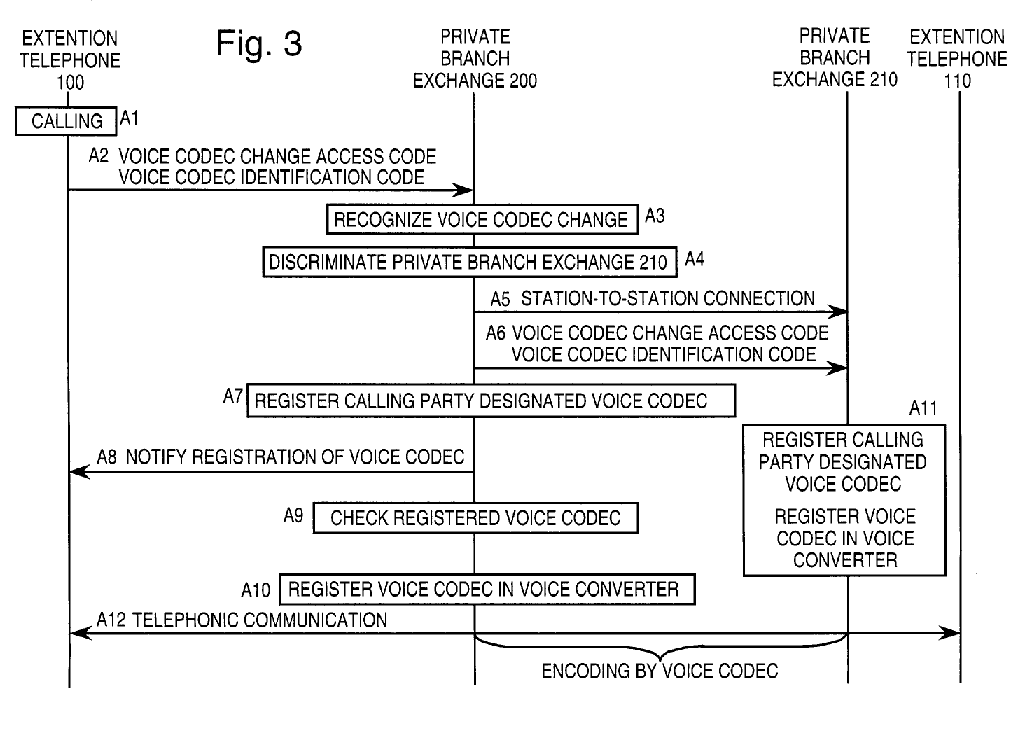

Now, an operation of the IP telephone system 10 of the shown embodiment will be described with reference to FIG. 3.

Here, before the start of the operation of the IP telephone system 10, the maintenance terminal 300 transmits the VoIP gateway information 220 to each of the private branch exchanges 200 and 210 through the IP network 400, so that the VoIP gateway information 220 excluding the calling party designated voice CODEC 224 is previously registered in each of the VoIP gateway information memories 202 and 212.

FIG. 3 is a flow chart illustrating the case that a calling is sent from the extension telephone set 100 connected to the private branch exchange 200 to the extension telephone set 110 connected to the private branch exchange 210, with designating the voice CODEC.

First, in a step A1, a subscriber of a calling party designates a desired voice CODEC by using the subscriber's extension telephone set 100, for example, by pushing the associated keyboard (not shown), and generates a calling.

As a result, as shown in a step A2, the subscriber's extension telephone set 100 sends, to the calling party side private branch exchange 200, a route access code and the telephone number of the destination extension telephone set 110, similarly to a conventional IP telephone system, and also a voice CODEC change access code and a voice CODEC identification node for designating the desired voice CODEC.

In response to these information, as shown in a step A3, the call controller 201 in the calling party side private branch exchange 200 recognizes the subscriber's intention of the voice CODEC change and the designated voice CODEC, from the voice CODEC change access code and the voice CODEC identification node, both sent as mentioned above. Furthermore, as shown in a step A4, on the basis of the route access code sent as mentioned above, the call controller 201 discriminates a called party side private branch exchange 210 to which the destination extension telephone set 110 is connected.

Succeedingly, as shown in a step A5, the call controller 201 of the calling party side private branch exchange 200 selects from a plurality of gateway circuits within the VoIP gateway card 203 a gateway circuit connectable through the IP network 400 to the call controller 211 within the called party side private branch exchange 210, so as to establish a station-to-station connection through the IP network 400 to the call controller 211 within the called party side private branch exchange 210, so that the extension telephone set 100 of the calling party side is interconnected with the extension telephone set 110 of the destination side or the called party side. Furthermore, as shown in a step A6, the call controller 201 of the calling party side private branch exchange 200 sends the voice CODEC change access code and the voice CODEC identification node to the called party side private branch exchange 210.

In addition, when it is judged by the call controller 201 that the station-to-station connection between the calling party side private branch exchange 200 and the called party side private branch exchange 210 passes through the VoIP gateway card 203, the voice CODEC 224 (voice CODEC “B”) designated by the calling party is registered as the calling party designated voice CODEC in addition to the voice CODEC 223 (voice CODEC “A”) corresponding to a selected gateway circuit 222 (for example, the gateway circuit “1” of the gateway “ID1”) in the VoIP gateway information 220 registered in the VoIP gateway information memory 202, as shown in a step A7.

Succeedingly, as shown in a step A8, the call controller 201 in the calling party side private branch exchange 200 sends, to the extension telephone set 100, the calling party designated voice CODEC 224 when the calling party designated voice CODEC 224 has been registered normally, or the identification code of the voice CODEC 223 when the calling party designated voice CODEC 224 has not been registered normally. The voice CODEC thus sent is displayed in the display part 101, or alternatively, a tone indicative of the voice CODEC 223 or 224 is transferred to the extension telephone set 100, so that a speaker of the extension telephone set 100 is rang. Thus, the calling party is notified of the kind of the selected voice CODEC, namely, whether or not the calling party designated voice CODEC 224 has been registered normally.

Thereafter, as shown in a step A9, the call controller 201 in the calling party side private branch exchange 200 checks whether or not the calling party designated voice CODEC 224 has been written for the selected gateway circuit 222 of the VoIP gateway information 220 registered in the VoIP gateway information memory 202. When the calling party designated voice CODEC has been written, the calling party designated voice CODEC 224 is in priority over the voice CODEC 223 set by the maintenance terminal 300, and therefore, as shown in a step A10, the call controller 201 registers the calling party designated voice CODEC 224 into the voice converter 204 of the VoIP gateway card 203 in connection with the selected gateway circuit 222.

However, when the calling party designated voice CODEC 224 has not been written, the call controller 201 registers the voice CODEC 223 set by the maintenance terminal 300, into the voice converter 204 of the VoIP gateway card 203 in connection with the selected gateway circuit 222.

On the other hand, a processing similar to the processing of the steps A7 to A10 carried out in the calling party side private branch exchange 200, is carried out in the called party side private branch exchange 210. Namely, as shown in a step A11, on the basis of the voice CODEC change access code and the voice CODEC identification node sent through the IP network 400 from the calling party side private branch exchange 200 (in the step A6), the calling party designated voice CODEC 224 is registered in the VoIP gateway information 220 in the VoIP gateway information memory 212, and furthermore, the calling party designated voice CODEC 224 is registered into the voice converter 214 of the VoIP gateway card 213 in connection with the selected gateway circuit 222.

Thus, in both the private branch exchanges 200 and 210 of the calling party side and the called party side, the calling party designated voice CODEC 224 is registered in the voice converters 204 and 214 in connection with the respectively selected gateway circuits 222.

Accordingly, as shown in a step A12, a voice telephone communication can be realized between the extension telephone sets 100 and 110.

In this process, the gateway circuit 222 selected in the VoIP gateway cards 203 and 213 of the private branch exchanges 200 and 210 carries out the voice conversion in accordance with the calling party designated voice CODEC 224.

Accordingly, a voice signal sent from the extension telephone set 100 is converted or encoded into a voice code by the voice converter 204 of the VoIP gateway card 203 within the private branch exchange 200, and the voice code is transmitted in the form of a packet through the IP network 400 to the private branch exchange 210. The voice code is converted or decoded into a voice signal by the voice converter 214 of the VoIP gateway card 213 within the private branch exchange 210, and the voice signal is sent to the extension telephone set 110.

Similarly, a voice signal sent from the extension telephone set 110 is converted or encoded into a voice code by the voice converter 214 of the VoIP gateway card 213 within the private branch exchange 210, and the voice code is transmitted in the form of a packet through the IP network 400 to the private branch exchange 200. The voice code is converted or decoded into a voice signal by the voice converter 204 of the VoIP gateway card 203 within the private branch exchange 200, and the voice signal is sent to the extension telephone set 100.

At this time, in both the voice converters 204 and 214, the voice conversion is carried out by the calling party designated voice CODEC 224 which is the calling party designated voice CODEC “B”, not the voice CODEC “A” set by the maintenance terminal 300.

Accordingly, the voice telephone communication can be realized by using a voice CODEC needing a more wide bandwidth in accordance with the intention of a calling party, or another voice CODEC having a high compression ratio in the case of a bad channel situation. Thus, it is possible to designate an arbitrary voice CODEC in accordance with the traffic situation of the channel or in accordance with a desired voice quality.

As seen from the above, according to the present invention, when a voice telephone communication is carried out between talking terminals respectively connected to private branch exchanges interconnected through an IP network such as an Internet or an intranet, a voice telephone communication can be realized by arbitrarily designating a voice CODEC desired by the subscriber of a calling party, for example, a voice CODEC needing a more wide bandwidth, or a voice CODEC having a high compression ratio in the case of a bad channel situation, dependently upon the traffic situation of the channel or a desired voice quality.

The invention has thus been shown and described with reference to the specific embodiments. However, it should be noted that the present invention is in no way limited to the details of the illustrated structures but changes and modifications may be made within the scope of the appended claims.

1. In an IP telephone system enabling a voice telephone communication between a pair of subscriber's talking terminals connected respectively to a pair of private branch exchanges interconnected through an IP network, by utilizing VoIP gateway functions respectively provided in the pair of private branch exchanges and by registering a voice CODEC in a voice converter provided in each of the pair of private branch exchanges, a voice CODEC designating system having such a configuration in that
each of the subscriber's talking terminals has a means for sending a voice CODEC change designating access code and a voice CODEC designating code to the private branch exchange of a calling party side and the private branch exchange of a called party side, when the subscriber's talking terminal of said calling party side dispatches a telephone calling, and
each of said private branch exchanges discriminates said voice CODEC change designating access code supplied from the subscriber's talking terminal of said calling party side, and registers a voice CODEC designated by said voice CODEC designating code, into said voice converter provided in each of said private branch exchanges.

2. A voice CODEC designating system claimed in claim 1 wherein each of said private branch exchanges includes:
an access code discriminating means for discriminating said voice CODEC change designating access code from the subscriber's talking terminal of said calling party side;
a voice CODEC designating means for designating the voice CODEC on the basis of said voice CODEC designating code; and
a voice CODEC registering means for registering the voice CODEC designated by said voice CODEC designating means, into the corresponding voice converter.

3. A voice CODEC designating system claimed in claim 2 wherein each of said private branch exchanges further includes a voice CODEC registration notifying means for notifying to the subscriber's talking terminal of said calling party side, whether or not the voice CODEC designated by said voice CODEC designating means has been normally registered into the voice converter by said voice CODEC registering means.

4. A voice CODEC designating system claimed in claim 3 wherein each of said private branch exchanges is connected through said IP network to a maintenance terminal which previously sets a voice CODEC to the voice converter of each of said private branch exchanges, and
wherein when each of said private branch exchanges receives said voice CODEC change designating access code and said voice CODEC designating code supplied from the subscriber's talking terminal of said calling party side, each of said private branch exchanges preferentially registers the voice CODEC designated through the subscriber's talking terminal of said calling party side into the corresponding voice converter.

5. A voice CODEC designating system claimed in claim 4 wherein each of said private branch exchanges includes a plurality of VoIP gateway devices, and wherein said maintenance terminal defines a different gateway ID for each of said VoIP gateway devices, and sets a voice CODEC for each gateway ID.

6. A voice CODEC designating system claimed in claim 5 wherein when the subscriber's talking terminal of said calling party side dispatches the telephone calling, the private branch exchange connected to the subscriber's talking terminal of said calling party side identifies the private branch exchange connected to the subscriber's talking terminal of said called party side, and selects from said plurality of VoIP gateway devices the VoIP gateway device connectable to said private branch exchange connected to the subscriber's talking terminal of said called party side, and then, registers the voice CODEC designated through the subscriber's talking terminal of said calling party side, into the voice converter in the private branch exchange connected to the subscriber's talking terminal of said calling party side, for the VoIP gateway device thus selected.

7. A voice CODEC designating system claimed in claim 1 wherein each of said private branch exchanges is connected through said IP network to a maintenance terminal which previously sets a voice CODEC to the voice converter of each of said private branch exchanges, and
wherein when each of said private branch exchanges receives said voice CODEC change designating access code and said voice CODEC designating code supplied from the subscriber's talking terminal of said calling party side, each of said private branch exchanges preferentially registers the voice CODEC designated through the subscriber's talking terminal of said calling party side into the corresponding voice converter.

8. A voice CODEC designating system claimed in claim 7 wherein each of said private branch exchanges includes a plurality of VoIP gateway devices, and wherein said maintenance terminal defines a different gateway ID for each of said VoIP gateway devices, and sets a voice CODEC for each gateway ID.

9. A voice CODEC designating system claimed in claim 8 wherein when the subscriber's talking terminal of said calling party side dispatches the telephone calling, the private branch exchange connected to the subscriber's talking terminal of said calling party side identifies the private branch exchange connected to the subscriber's talking terminal of said called party side, and selects from said plurality of VoIP gateway devices the VoIP gateway device connectable to said private branch exchange connected to the subscriber's talking terminal of said called party side, and then, registers the voice CODEC designated through the subscriber's talking terminal of said calling party side, into the voice converter in the private branch exchange connected to the subscriber's talking terminal of said calling party side, for the VoIP gateway device thus selected.

10. A voice CODEC designating system claimed in claim 2 wherein each of said private branch exchanges is connected through said IP network to a maintenance terminal which previously sets a voice CODEC to the voice converter of each of said private branch exchanges, and
wherein when each of said private branch exchanges receives said voice CODEC change designating access code and said voice CODEC designating code supplied from the subscriber's talking terminal of said calling party side, each of said private branch exchanges preferentially registers the voice CODEC designated through the subscriber's talking terminal of said calling party side into the corresponding voice converter.

11. A voice CODEC designating system claimed in claim 10 wherein each of said private branch exchanges includes a plurality of VoIP gateway devices, and wherein said maintenance terminal defines a different gateway ID for each of said VoIP gateway devices, and sets a voice CODEC for each gateway ID.

12. A voice CODEC designating system claimed in claim 11 wherein when the subscriber's talking terminal of said calling party side dispatches the telephone calling, the private branch exchange connected to the subscriber's talking terminal of said calling party side identifies the private branch exchange connected to the subscriber's talking terminal of said called party side, and selects from said plurality of VoIP gateway devices the VoIP gateway device connectable to said private branch exchange connected to the subscriber's talking terminal of said called party side, and then, registers the voice CODEC designated through the subscriber's talking terminal of said calling party side, into the voice converter in the private branch exchange connected to the subscriber's talking terminal of said calling party side, for the VoIP gateway device thus selected.
